(19) United States
(12) Patent Application Publication
(10) Pub. No.: US 2006/0075409 A1
(43) Pub. Date: Apr. 6, 2006

(54) Cartridge for protecting a data carrier

(75) Inventors: Frank Cornelis Penning, Eindhoven (NL); Jacobus Josephus Maria Ruigrok, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,926

(22) PCT Filed: Oct. 14, 2003
(86) PCT No.: PCT/IB03/04544

§ 371 Date: Apr. 27, 2005

(30) Foreign Application Priority Data
Oct. 31, 2002 (EP) 02292734.7

(51) Int. Cl. G11B 33/02

(52) U.S. Cl. 720/600

(57) ABSTRACT

The present invention relates to a cartridge (4) for a data carrier (3) comprising two flexible halves (4a-4b) for protecting the data carrier. The flexible halves comprise means for disassembling the halves when the data carrier is inserted into a device (1) for processing the data carrier and for reassembling said halves when the data carrier is removed from said device. In an embodiment of the invention, the cartridge halves are rolled up by rolling-up means (2a-2b) included in the cartridge or in the processing device.

### FIELD OF THE INVENTION

The present invention relates to a cartridge for protecting a data carrier in a dirty and damaging environment.

The present invention also relates to device for processing said cartridge and to a recording and/or reproducing device comprising said processing device.

This invention is particularly relevant for optical discs and more particularly for small form factor optical SFFO discs.

### BACKGROUND OF THE INVENTION

Conventional disc cartridges can be relatively thick. They typically have a thickness of at least 2 to 3 times the disc thickness. Such a cartridge is described, for example, in U.S. Pat. No. 4,879,710.

As we are mainly considering a small form factor optical SFFO drive application here, a disc has dimensions of roughly 30 mm diameter and 0.5 mm thickness. Taking into account the best plastic molding technology, one would end up by adding two times 0.3 mm of plastic cover, two times an air gap of typically 0.2 mm and maybe even a slider to open the cartridge. This would give a cartridge thickness of about 1.5 to 2 mm.

### SUMMARY OF THE INVENTION

It is an object of the invention to propose a cartridge for protecting a small form factor optical disc in a dirty and damaging environment which has a very small contribution to the height of the device for processing the data carrier, i.e. the disc drive.

To this end, the cartridge in accordance with the invention comprises two flexible halves for protecting the data carrier. Said flexible halves comprise means for disassembling said halves when the data carrier is inserted into a device for processing said data carrier and for reassembling the halves when the data carrier is removed from said device.

Thanks to the disassembling-reassembling means, the cartridge halves can be separated outside the device for processing the data carrier. As a consequence, only the data carrier is inserted into said processing device and adds to the height of the processing device.

In a first embodiment, the halves are rolled up thanks to rolling-up means included in the cartridge or in the processing device.

In another embodiment, the halves are stored locally in that they are shifted into two compartments on either side of the processing device.

When the data carrier is in the cartridge, the two cartridge halves are held together thanks to the disassembling-reassembling means such as an adhesive layer, plastic-bonded ferrite material combined with a ridge and counter-ridge, or a zipper-like structure.

### BRIEF DESCRIPTION OF THE DRAWINGS

The present invention will now be described in more detail, by way of example, with reference to the accompanying drawings, wherein:

FIG. 1 depicts how an optical disc contained in a cartridge is inserted into an optical drive, according to a first embodiment of the invention,

FIG. 2 illustrates the operation of rolling-up means in accordance with the first embodiment of the invention,

FIG. 3 is a perspective view of the cartridge and its corresponding processing device in accordance with the first embodiment of the invention,

FIG. 4 depicts how an optical disc contained in a cartridge is inserted into an optical drive, according to a second embodiment of the invention,

FIG. 5 is a perspective view of the cartridge in accordance with the invention,

FIG. 6 shows an example of means for disassembling and reassembling the halves of a cartridge using adhesive strips,

FIGS. 7a and 7b show two examples of means for disassembling and reassembling the halves of a cartridge using magnetic strips, and

FIG. 8 shows an example of means for disassembling and reassembling the halves of a cartridge using a zipper-like structure.

### DETAILED DESCRIPTION OF THE INVENTION

The present invention relates to a cartridge for a data carrier of the small form factor optical SFFO disc type, for example. Said cartridge comprises two flexible halves for protecting the data carrier. It will be apparent to a person skilled in the art that the invention is not limited to SFFO discs but is equally applicable to cartridges capable of containing all types of data carrier that are exposed to a dirty and damaging environment.

The halves of the cartridge in accordance with the invention are disassembled when the data carrier is inserted into a device for processing the data carrier and reassembled when the data carrier is removed from said device. The processing device is an optical drive in the case of an optical disc.

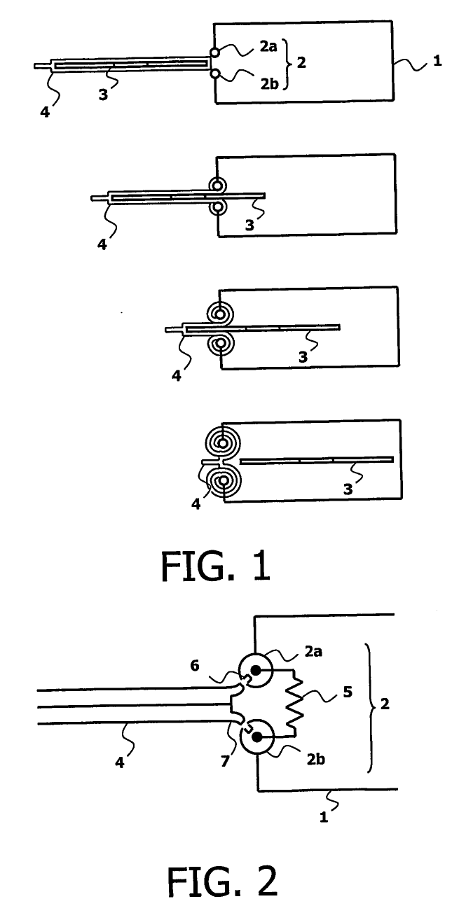

FIG. 1 depicts an optical drive (1) having a loading space (2) through which a disc can be loaded. The loading space has two rollers (2a-2b) onto which the flexible halves of a cartridge (4) containing a disc (3) may roll up. This automatically inserts the disc into the optical drive. At the same time, the thin flexible halves that surround the disc are stored on the rollers.

An important aspect of the invention is that the cartridge is made of a flexible, transparent or non-transparent material like rubber, plastic, or an equivalent material. In order to be robust, the material is wear-resistant and may or may not be covered with special protective layers.

An advantage of the present invention is that the cartridge covering the disc does not enter the disc drive or is stored in a small part of said disc drive. The building height of the drive can then be reduced with respect to a solution with a conventional cartridge technology. Moreover, the cartridge halves roll up just outside the disc drive, thereby taking up a minimum of space.

For a small form factor optical drive, the present invention typically aims at a building height of the complete drive of 5 mm, which is also the height of PCMCIA type II and Compact Flash type II interfaces. By using highly miniaturized optical and mechanical components, this can be realized in conventional cartridge technology. This is easier to attain with a cartridge in accordance with the present invention, and ultimately the 5 mm barrier can be lowered towards a 4 to 3 mm building height, whereas a compact flash type I has a building height of 3.3 mm.

Another advantage of the present invention is that the complete surface area of the cartridge can be available for labeling purposes.

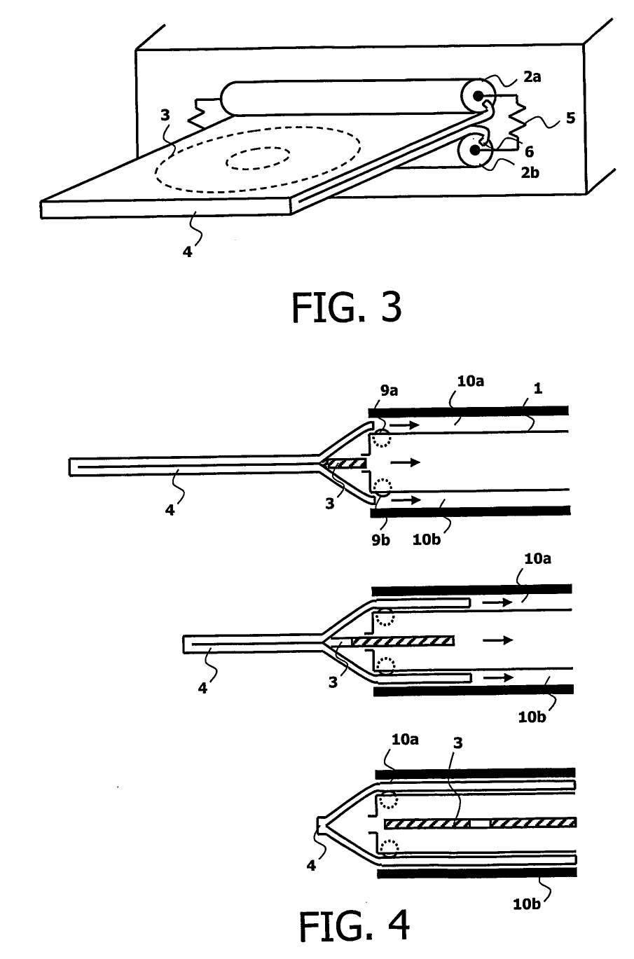

In a specific embodiment of the invention, the rolling-up means (2) are an intrinsic part of the optical drive (1) and comprise means for gripping the halves of the cartridge in order to roll them up. The gripping means are, for example, a groove (6) provided within the rollers as depicted in FIG. 2 and in the perspective view of FIG. 3, said groove being able to receive a corresponding projection (7) of the halves. The rolling-up means are supplied by conventional electric means (5).

In another embodiment of the invention, the rolling-up means (2) are an intrinsic part of the cartridge.

Still in another embodiment of the invention, depicted in FIG. 4, the two flexible halves covering the disc are stored locally without being rolled up. In our example, the halves are shifted into two compartments (10a-10b) outside the drive (1) thanks to the use of a roller (9a,9b) capable of guiding each half linearly.

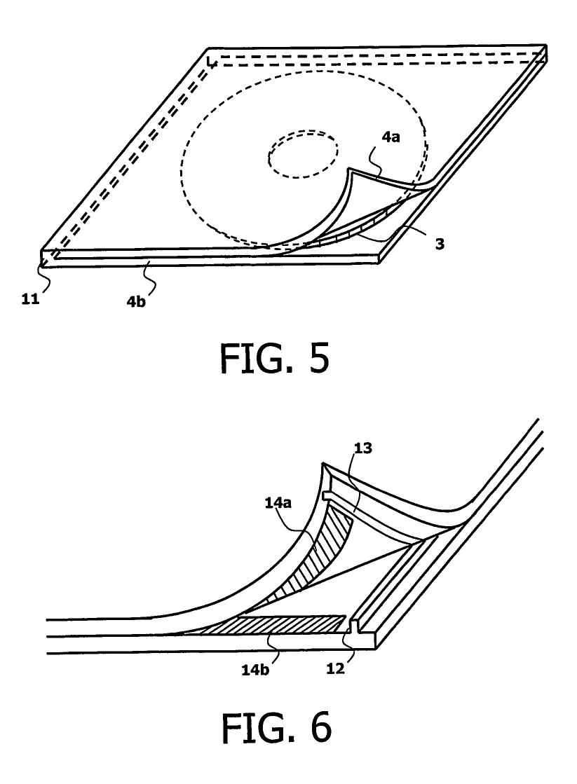

FIG. 5 is a perspective view of a cartridge comprising a flexible plastic cover (4a,4b) in which the disc (3) is placed as, for example, in an envelope. The disc (3) is taken from the cartridge by rolling-up or shifting of the two flexible plastic sheets (4a-4b), as was described above. Typically, the two halves are sealed at the back-end (11) of the cartridge.

The cartridge shown in FIG. 5 is made more robust when the two cartridge halves (4a-4b) stick together when holding the cartridge. Indeed, if the cartridge is carried about in a pocket trouser, the sides are not allowed to fold up, as this will expose the disc to dust and make it more sensitive to damage.

In a specific embodiment of the invention, the cartridge halves (4a-4b) are held together by some adhesive layer. In FIG. 6, each half of the cartridge comprises shaded areas (14a,14b), which are sticky strips in this case.

In another specific embodiment of the invention, also represented in FIG. 6, a ridge (12) is made in the front end of a first half of the cartridge, said ridge corresponding to a groove (13) in the second half of the cartridge, the ridge and groove being such that the cartridge halves cannot shift with respect to each other.

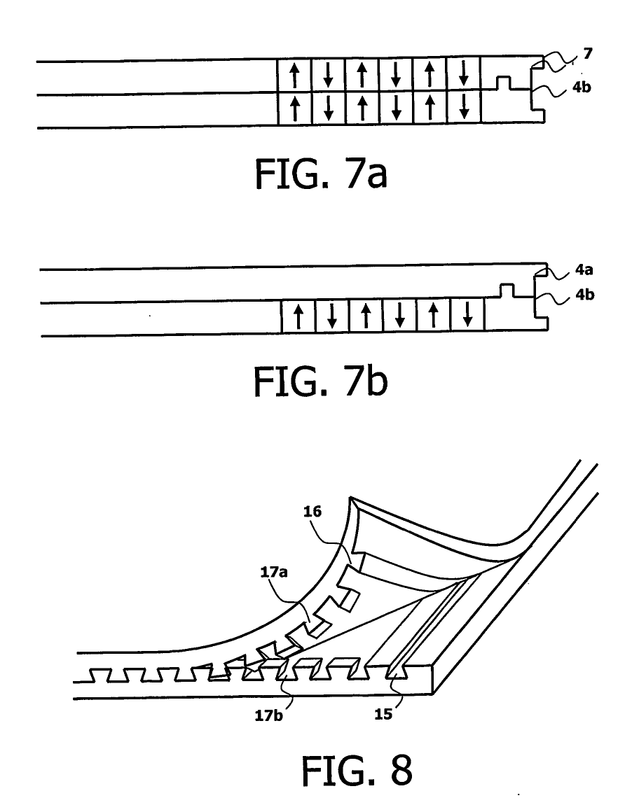

In another specific embodiment of the invention, the halves are held together by magnetic force instead of adhesive layers. The shaded areas in FIG. 6 (14a-14b) are then made of, for example, plastic-bonded ferrite. This material is flexible and is widely used in, for example, magnetic seals of doors of refrigerators. This material is magnetized to form magnetic strips. In order to increase the sticking force of these magnetic strips, it is advantageous to apply a magnetic pattern in one or both strips. In a specific embodiment, the magnetic patterns in both strips coincide, as shown in FIG. 7a in which an arrow indicates the direction of magnetization, and form a periodic pattern along a longitudinal direction of both strips. In another embodiment, a periodic strip is made in one of the strips and the other strip is made of a soft magnetic material as shown in FIG. 7b. It will be apparent to a person skilled in the art that other patterns over the length and width directions of the strips can be envisaged so as to have an optimized sticking force.

In another specific embodiment of the invention, the cartridge comprises a zipper-like mechanical structure as shown in FIG. 8. Here a front ridge is defined using a groove (15) over most of the front edge, said groove being made in the first half of the cartridge, and a corresponding ridge (16) in the second half of the cartridge. Two corresponding sides of the halves of the cartridge are held together by small protuberances (17a) and cavities (17b) that fit together. FIG. 8 schematically shows a zipper-like structure to open and close the cartridge. As is not shown in this Figure, but in reality is often the case is that both halves come loose when they are bend. This is the basic principle of a ‘zipper’ mechanism.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A cartridge (4) for a data carrier (3) comprising two flexible halves (4a-4b) for protecting the data carrier, said flexible halves comprising means for disassembling said halves when the data carrier is inserted into a device (1) for processing the data carrier and for reassembling the halves when the data carrier is removed from said device, said cartridge further comprising means for rolling-up (2a-2b) the flexible halves.

2. A cartridge (4) as claimed in claim 1, wherein the disassembling-reassembling means (14a-14b) comprise adhesive layers.

3. A cartridge (4) as claimed in claim 1, wherein the disassembling-reassembling means (14a-14b) comprise a magnetized plastic-bonded material.

4. A cartridge (4) as claimed in claim 1, wherein the disassembling-reassembling means comprise protuberances (17a) and cavities (17b) capable of making the halves of the cartridge fit together.

5. A cartridge (4) as claimed in claim 1, wherein the disassembling-reassembling means (14a-14b,17a-17b) comprise a ridge (12,16) and a groove (13,15).

6. A device for processing (1) a cartridge (4) for a data carrier (3) comprising two flexible halves (4a,4b) for protecting the data carrier, the flexible halves comprising means for disassembling said halves when the data carrier is inserted into the processing device and for reassembling the halves when the data carrier is removed from the processing device, the processing device comprising means for receiving (2a-2b,9a-9b-10a-10b) the flexible halves, said processing device (1) comprising means for rolling-up (2a-2b) the flexible halves.

7. A recording and/or reproducing device comprising a processing device (1) as claimed in claim 6.
